(19) United States
(12) Patent Application Publication
(10) Pub. No.: US 2022/0018306 A1
(43) Pub. Date: Jan. 20, 2022

(54) BORE LINER INSERT FOR CAST ENGINE BLOCK

(71) Applicants: Patrick H. Baer, Clarkston, MI (US); Jeffrey Brand, Highland, MI (US); Pietro A. Monaco, Shelby Township, MI (US); Anthony J. Denouden, Lake Orion, MI (US); Alan Falkowski, Lake Orion, MI (US)

(72) Inventors: Patrick H. Baer, Clarkston, MI (US); Jeffrey Brand, Highland, MI (US); Pietro A. Monaco, Shelby Township, MI (US); Anthony J. Denouden, Lake Orion, MI (US); Alan Falkowski, Lake Orion, MI (US)

(21) Appl. No.: 16/929,443

(22) Filed: Jul. 15, 2020

(51) Int. Cl. F02F 1/00; F02F 1/16; F02F 1/14

(52) U.S. Cl. CPC F02F 1/004; F02F 2200/00; F02F 1/14; F02F 1/16

(57) ABSTRACT

A cylinder bore liner insert configured to be cast in an internal combustion engine block includes an additive manufactured liner wall formed during an additive manufacturing process and having an inner surface, an outer surface, and an upper surface configured to be operably associated with a cylinder head, wherein the inner surface at least partially defines a cylinder bore configured to receive a piston therein. A liner water jacket is defined internally within the additive manufactured liner wall during the additive manufacturing process. The liner water jacket at least partially surrounds the cylinder bore to provide cooling thereto via a flow of coolant within the liner water jacket. A plurality of coolant ports are formed in the upper surface and configured to enable flow of coolant between the liner water jacket and the cylinder head.

### FIELD

The present application relates generally to internal combustion engines and, more particularly, to an additive manufactured cylinder bore liner insert for a cast engine block.

### BACKGROUND

Some internal combustion engines include cylinder bore walls made of a material configured to withstand the abrasive action of the combustion seal rings of a reciprocating piston. In traditional cast iron engine blocks, the cast iron material provides sufficient wear resistance to the seal rings. However, some engine blocks are cast from a lighter material, such as aluminum, and require liners to be inserted into the cylinder bores to provide the required wear resistance. Such conventional liners, however, do not include complex cored passages and/or conjoined liners due to manufacturing complexities. Thus, while such conventional liner systems do work well for their intended purpose, there remains a desire for improvement in the relevant art.

### SUMMARY

According to one example aspect of the invention, a cylinder bore liner insert configured to be cast in an internal combustion engine block is provided. In one example configuration, the cylinder bore liner insert includes an additive manufactured liner wall formed during an additive manufacturing process and having an inner surface, an outer surface, and an upper surface configured to receive or be operably associated with a cylinder head, wherein the inner surface at least partially defines a cylinder bore configured to receive a piston therein. A liner water jacket is defined internally within the additive manufactured liner wall during the additive manufacturing process. The liner water jacket at least partially surrounds the cylinder bore to provide cooling thereto via a flow of coolant within the liner water jacket. A plurality of coolant ports is formed in the upper surface and configured to enable flow of coolant between the liner water jacket and the cylinder head.

In addition to the foregoing, the described cylinder bore liner insert may include one or more of the following features: wherein the additive manufactured liner wall includes a straight-walled cylindrical lower section and a bowl-like upper section; wherein the outer surface of the bowl-like upper section is curved to facilitate distributing casting forces experienced during the casting of the cylinder bore liner insert within the engine block; wherein the additive manufactured liner wall comprises a plurality of additive manufactured liner walls defining a plurality of cylinder bores, wherein adjacent additive manufactured liner walls are integrally formed during an additive manufacturing process to define conjoined cylinder bores; and wherein the liner water jacket includes an interbore portion disposed within the additive manufactured liner walls between the conjoined cylinder bores to provide cooling therebetween.

In addition to the foregoing, the described cylinder bore liner insert may include one or more of the following features: an interbore coolant port fluidly coupling the interbore portion and the cylinder head to facilitate coolant flow between the adjacent conjoined cylinder bores; wherein the interbore coolant port includes a first inlet/outlet, a second inlet/outlet, and is defined by a pair of opposed side walls, a bottom wall, and the upper surface; and a plurality of projections extending outwardly from the outer surface, the plurality of projections formed integrally with the additive manufactured liner wall during the additive manufacturing process, wherein the plurality of projections are configured to facilitate mechanically locking the cylinder bore liner insert during the casting of the cylinder bore liner insert within the engine block.

In addition to the foregoing, the described cylinder bore liner insert may include one or more of the following features: wherein the plurality of projections comprises a plurality of fins; wherein the plurality of fins is dovetailed; a plurality of projections extending inwardly from the inner surface into the cylinder bore, the plurality of projections formed integrally with the additive manufactured liner wall during the additive manufacturing process; a spray bore liner sprayed onto the inner surface and mechanically locked with the plurality of projections; and wherein the plurality of projections comprises a plurality of dovetailed fins.

According to another example aspect of the invention, a method of manufacturing a cylinder bore liner insert configured to be cast in an internal combustion engine block is provided. In one example configuration, the method includes performing an additive manufacturing process including forming a liner wall having an inner surface, an outer surface, and an upper surface configured to be operably associated with a cylinder head, wherein the inner surface at least partially defines a cylinder bore configured to receive a piston therein. The method further includes forming a liner water jacket internally within the liner wall, the liner water jacket at least partially surrounding the cylinder bore to provide cooling thereto via a flow of coolant within the liner water jacket, and forming a plurality of coolant ports in the upper surface, the plurality of coolant ports configured to enable flow of coolant between the liner water jacket and the cylinder head.

In addition to the foregoing, the described method may include one or more of the following features: wherein the additive manufacturing process further includes forming a plurality of projections extending outwardly from the outer surface, the plurality of projections configured to facilitate mechanically locking the cylinder bore liner insert during the casting of the cylinder bore liner insert within the engine block; wherein the additive manufacturing process further includes a plurality of projections extending inwardly from the inner surface into the cylinder bore; and spraying a bore liner onto the inner surface and mechanically locked with the plurality of projections.

According to another example aspect of the invention, a cylinder bore liner insert configured to be cast in an internal combustion engine block is provided. In one example configuration, the cylinder bore liner insert includes a plurality of additive manufactured liner walls formed during an additive manufacturing process and each having an inner surface, an outer surface, and an upper surface configured to be operably associated with a cylinder head, wherein the inner surface at least partially defines a cylinder bore configured to receive a piston therein. A liner water jacket is defined internally within the plurality of additive manufactured liner walls during the additive manufacturing process, the liner water jacket at least partially surrounding each cylinder bore to provide cooling thereto via a flow of coolant within the liner water jacket. A plurality of coolant ports is formed in the upper surface and configured to enable flow of coolant between the liner water jacket and the cylinder head. Each additive manufactured liner wall includes a straight-walled cylindrical lower section and a bowl-like upper section. The outer surface of the bowl-like upper section is curved to facilitate distributing casting forces experienced during the casting of the cylinder bore liner insert within the engine block. The water jacket includes an interbore portion disposed within the additive manufactured liner walls between the conjoined cylinder bores to provide cooling therebetween. A first plurality of projections extends outwardly from the outer surface and are formed integrally with the additive manufactured liner wall during the additive manufacturing process. The first plurality of projections is configured to facilitate mechanically locking the cylinder bore liner insert during the casting of the cylinder bore liner insert within the engine block. A second plurality of projections extend inwardly from the inner surface into the cylinder bore. The second plurality of projections is formed integrally with the additive manufactured liner wall during the additive manufacturing process. A spray bore liner is sprayed onto the inner surface and mechanically locked with the second plurality of projections.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings references therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a perspective view of an example cylinder bore liner insert, in accordance with the principles of the present disclosure;

FIG. 2 is a sectional view of the cylinder bore liner insert shown in FIG. 1 and taken along line 2-2, in accordance with the principles of the present disclosure;

FIG. 3 is a sectional view of the cylinder bore liner insert shown in FIG. 1 and taken along line 3-3, in accordance with the principles of the present disclosure; and

FIG. 4 is an enlarged view of example inward dovetails that may be formed on the cylinder bore liner insert shown in FIG. 1, in accordance with the principles of the present disclosure.

### DESCRIPTION

The present application is directed to an additive manufactured cylinder bore liner insert for a cast (e.g., aluminum) engine block. The liner insert includes thin-shelled cylinder bores conjoined or integrally coupled to each other with intricate cored passages therebetween which would otherwise be difficult or impossible to cast. Additionally, the outer surface of the liner insert includes a plurality of fins or dovetails to facilitate bonding or adhesion of the bore liner insert to the parent metal of the cast engine block. As such, the additive manufactured cylinder bore liner insert is a precision cast in place component that provides excellent structural rigidity, a post machined/honed bore surface resistant to acids from exhaust gas recirculation, and includes internal coolant passages configured to provide a uniform bore wall temperature at a variety of operating speeds and loads.

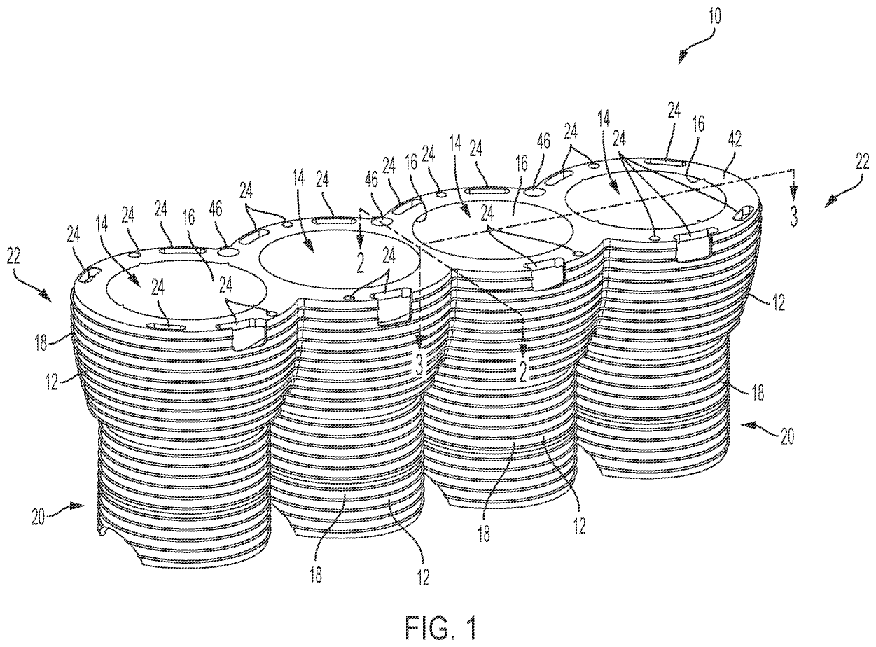

Referring now to the drawings, FIG. 1 illustrates an example cylinder bore liner insert 10 configured to be disposed within cylinder bores of an engine block (not shown). In the example embodiment, cylinder bore liner insert 10 is fabricated from an additive manufacturing process such as, for example, binder jetting, directed energy deposition, material jetting, material extrusion, sheet lamination, and vat polymerization. The cylinder bore liner insert 10 may be fabricated from any suitable wear resistant material such as, for example, steel. The additive manufacturing process enables cylinder bore liner insert 10 to be formed with unique features including internal coolant passages, internal coolant chambers, and interfacing fins and/or dovetails, as described herein in more detail.

In the example embodiment, the cylinder bore liner insert 10 is configured to be integrated into an in-line die cast aluminum four-cylinder engine block (not shown). However, it will be appreciated that cylinder bore liner insert 10 may have various other arrangements or configurations and can be configured to be integrated into various types of engine blocks by various casting methods such as, for example, die casting and sand casting. In the illustrated example, cylinder bore liner insert 10 is formed in an in-line conjoined (e.g., “Siamese”) configuration, as shown in FIG. 1. In one example, once the cylinder bore liner insert 10 is fabricated via additive manufacturing, the insert 10 is subsequently cast inside a casting mold of the engine block. However, it will be appreciated that other methods for coupling or integrating the cylinder bore liner insert 10 into the engine block are envisioned.

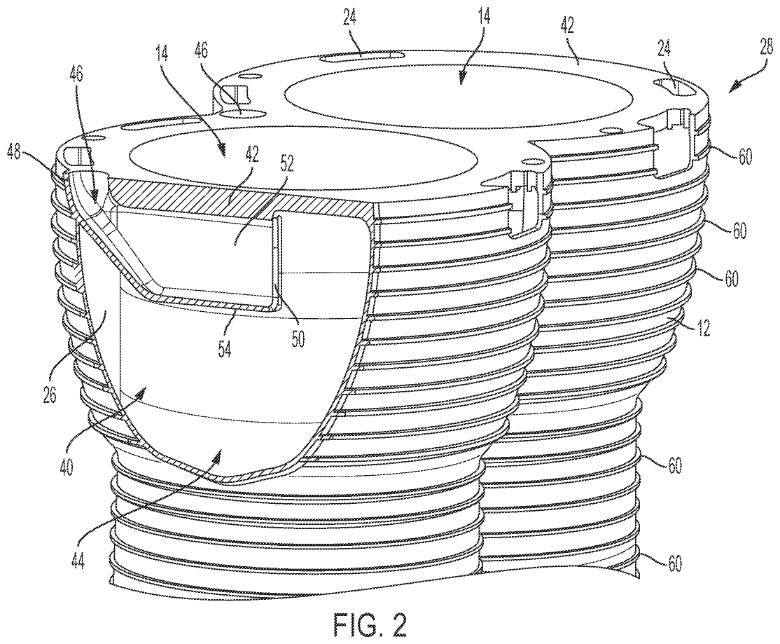

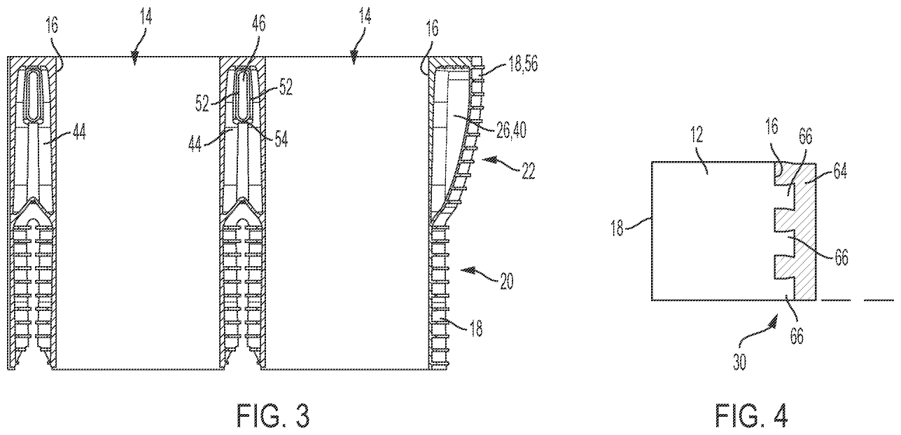

With additional reference to FIGS. 2 and 3, in the example embodiment, cylinder bore liner insert 10 generally includes thin liner walls 12 defining a plurality (e.g., four) of cylinder bores 14 each configured to receive a piston (not shown) for reciprocating movement therein. Each liner wall 12 includes an inner surface 16 and an outer surface 18 and generally defines a straight-walled cylindrical lower section 20, and a bowl-like upper section 22. The inner surface 16 at least partially defines the cylinder bores 14. As shown in FIGS. 2 and 3, a plurality of coolant channels or ports 24 and coolant chambers 26 are defined within the liner wall 12 and, as shown in FIGS. 3 and 4, liner wall 12 can be formed with a plurality of external or internal projections 28, 30, as described herein in more detail.

With continued reference to FIGS. 2 and 3, each upper section 22 defines an internal coolant chamber 26 that at least partially surrounds the cylinder bore 14 to provide cooling thereto. In the example embodiment, the internal coolant chambers 26 of each upper section 22 are fluidly coupled to each other such that a liner water jacket 40 is formed internally within liner walls 12. Further, the liner water jacket 40 is fluidly coupled to the cylinder head via coolant ports 24 formed in an upper surface 42, which is configured to receive and/or be disposed directly against the cylinder head. In alternative arrangements, upper surface 42 may be covered by cast material and various features (e.g., ports) are subsequently formed or machined to connect to coolant ports 24. As shown in FIG. 2, the liner water jacket 40 includes an interbore portion 44 disposed between adjacent cylinder bores 14 for fluidly coupling adjacent internal coolant chambers 26 to provide improved cooling between the cylinder bores 14 (e.g., interbore cooling) than standard castings.

Additionally, as shown in FIG. 2, an interbore coolant port 46 is configured to fluidly couple each liner water jacket interbore portion 44 with the cylinder head. In the illustrated example, the interbore coolant port 46 includes a first inlet/outlet 48 and a second inlet/outlet 50, and is defined by a pair of opposed side walls 52 (only one shown in FIG. 2), a bottom wall 54, and the upper surface 42. In this way, interbore coolant port 46 improves coolant flow in the interbore portion 44, thereby further providing improved cooling between the cylinder bores 14.

With continued reference to FIG. 3, the upper section 22 is at least partially defined by a curved outer surface 56. Not only does the curved outer surface 56 provide space for the internal coolant chambers 26, but the curved or arced shape is configured to reduce potential distortion by distributing casting forces that can occur when the cast engine block cools, shrinks, and causes compressive forces on the bore liner insert. In this way, the shape of curved outer surface 56 is designed to not only control distortion during casting, but also control cooling properties of the cylinder bore liner 10. However, it will be appreciated that the size and/or shape of coolant ports 24, coolant chambers 26, liner water jacket 40, and curved outer surface 56 may be varied based on thermal factors and requirements, and/or to maintain a predetermined velocity, speed, of fluid distribution within bore liner insert 10.

As shown in FIG. 3, liner walls 12 can be formed with a plurality of outwardly extending projections 28 configured to facilitate mechanical locking with the parent material of the engine block when the cylinder bore liner insert 10 is casted therein. In the illustrated example, the projections are a plurality of fins 60 extending outwardly from the outer surface 18, 56. In other configurations, fins 60 may extend inwardly into the coolant chambers 26 and liner water jacket 40 from internal surfaces 62 of the liner wall 12 to further facilitate cooling of the cylinder bores 14.

In some implementations, fins 60 may have a dovetail shape to further facilitate mechanical locking with the engine block. In one example, the fins 60 are defined at equally spaced intervals along the entire height of the bore liner insert 10 or only a portion of the height thereof. Additionally, each fin 60 can extend about an entire perimeter or circumference of the outer surface 18, 56, for example, on cylindrical lower section 20. In other examples, fins 60 extend about only a portion or portions of the entire perimeter or circumference of the outer surface 18, 56.

As shown in FIG. 4, liner walls 12 can be formed with a plurality of inwardly extending projections 30 configured to facilitate mechanical locking with a spray bore material 64 sprayed onto the liner wall inner surface 16. In the illustrated example, the projections are a plurality of dovetailed fins 66 extending inwardly from the inner surface 16 to facilitate mechanical locking with the spray bore material 64. Each dovetailed fin 66 can extend about an entire inner diameter or circumference of the inner surface 16, or only about a portion or portions thereof.

Described herein are systems and methods for an additive manufactured cylinder bore liner for a cast engine block. The bore liner is manufactured with integral cylinder bores with cooling passages therebetween to provide uniform bore wall temperatures at various operating loads and speeds. The bore liner outer surface is formed with a plurality of fins or dovetails configured to provide a mechanical bond between the parent cylinder block bore and the sprayed metal liner. Thus, the bore liner is produced without thin sand core interbores, spray bore liners or standard centrifugal cast liner methods. The described bore liner advantageously has zero draft, no parting lines, precision casting, minimized material usage, thin walls, advanced material properties, low porosity, and intricate cored coolant passages. In this way, the bore liner provides greater design freedom, reduced machine stock/waste, improved heat transfer, and coolant flow duct design.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present disclosure, its application or uses. Thus, variations that do not depart from the gist of the present disclosure are intended to be within the scope of the present disclosure.

1. A cylinder bore liner insert configured to be cast in an internal combustion engine block, the cylinder bore liner insert comprising:
an additive manufactured liner wall formed during an additive manufacturing process and having an inner surface, an outer surface, and an upper surface configured to be operably associated with a cylinder head, wherein the inner surface at least partially defines a cylinder bore configured to receive a piston therein;
a liner water jacket defined internally within the additive manufactured liner wall during the additive manufacturing process, the liner water jacket at least partially surrounding the cylinder bore to provide cooling thereto via a flow of coolant within the liner water jacket; and
a plurality of coolant ports formed in the upper surface and configured to enable flow of coolant between the liner water jacket and the cylinder head.

2. The cylinder bore liner insert of claim 1, wherein the additive manufactured liner wall includes a straight-walled cylindrical lower section and a bowl-like upper section.

3. The cylinder bore liner insert of claim 2, wherein the outer surface of the bowl-like upper section is curved along its entirety from the straight-walled cylindrical lower section to the upper surface to facilitate distributing casting forces experienced during the casting of the cylinder bore liner insert within the engine block.

4. The cylinder bore liner insert of claim 1, wherein the additive manufactured liner wall comprises a plurality of additive manufactured liner walls defining a plurality of cylinder bores, wherein adjacent additive manufactured liner walls are integrally formed during an additive manufacturing process to define conjoined cylinder bores.

5. The cylinder bore liner insert of claim 4, wherein the liner water jacket includes an interbore portion disposed within the additive manufactured liner walls between the conjoined cylinder bores to provide cooling therebetween.

6. The cylinder bore liner insert of claim 5, further comprising an interbore coolant port fluidly coupling the interbore portion and the cylinder head to facilitate coolant flow between the adjacent conjoined cylinder bores.

7. The cylinder bore liner insert of claim 6, wherein the interbore coolant port includes a first inlet/outlet, a second inlet/outlet, and a chamber defined by a pair of opposed side walls, a bottom wall, and the upper surface,
wherein the chamber is fluidly coupled to the cylinder head via the first inlet/outlet, and fluidly coupled to the water jacket interbore portion via the second inlet/outlet.

8. The cylinder bore liner insert of claim 1, further comprising a plurality of projections extending outwardly from the outer surface, the plurality of projections formed integrally with the additive manufactured liner wall during the additive manufacturing process, wherein the plurality of projections are configured to facilitate mechanically locking the cylinder bore liner insert during the casting of the cylinder bore liner insert within the engine block.

9. The cylinder bore liner insert of claim 8, wherein the plurality of projections comprises a plurality of fins.

10. The cylinder bore liner insert of claim 9, wherein the plurality of fins is dovetailed.

11. The cylinder bore liner insert of claim 1, further comprising a plurality of projections extending inwardly from the inner surface into the cylinder bore, the plurality of projections formed integrally with the additive manufactured liner wall during the additive manufacturing process.

12. The cylinder bore liner insert of claim 11, further comprising a spray bore liner sprayed onto the inner surface and mechanically locked with the plurality of projections.

13. The cylinder bore liner insert of claim 12, wherein the plurality of projections comprises a plurality of dovetailed fins.

14. A method of manufacturing a cylinder bore liner insert configured to be cast in an internal combustion engine block, the method comprising:
performing an additive manufacturing process including:
forming a liner wall having an inner surface, an outer surface, and an upper surface configured to be operably associated with a cylinder head, wherein the inner surface at least partially defines a cylinder bore configured to receive a piston therein;
forming a liner water jacket internally within the liner wall, the liner water jacket at least partially surrounding the cylinder bore to provide cooling thereto via a flow of coolant within the liner water jacket; and
forming a plurality of coolant ports in the upper surface, the plurality of coolant ports configured to enable flow of coolant between the liner water jacket and the cylinder head.

15. The method of claim 14, wherein the additive manufacturing process further includes forming a plurality of projections extending outwardly from the outer surface, the plurality of projections configured to facilitate mechanically locking the cylinder bore liner insert during the casting of the cylinder bore liner insert within the engine block.

16. The method of claim 14, wherein the additive manufacturing process further includes forming a plurality of projections extending inwardly from the inner surface into the cylinder bore.

17. The method of claim 16, further comprising spraying a bore liner onto the inner surface and mechanically locked with the plurality of projections.

18. A cylinder bore liner insert configured to be cast in an internal combustion engine block, the cylinder bore liner insert comprising:
a plurality of additive manufactured liner walls formed during an additive manufacturing process and each having an inner surface, an outer surface, and an upper surface configured to be operably associated with a cylinder head, wherein the inner surface at least partially defines a cylinder bore configured to receive a piston therein;
a liner water jacket defined internally within the plurality of additive manufactured liner walls during the additive manufacturing process, the liner water jacket at least partially surrounding each cylinder bore to provide cooling thereto via a flow of coolant within the liner water jacket;
a plurality of coolant ports formed in the upper surface and configured to enable flow of coolant between the liner water jacket and the cylinder head;
wherein each additive manufactured liner wall includes a straight-walled cylindrical lower section and a bowl-like upper section, wherein the outer surface of the bowl-like upper section is curved to facilitate distributing casting forces experienced during the casting of the cylinder bore liner insert within the engine block;
wherein the water jacket includes an interbore portion disposed within the additive manufactured liner walls between the conjoined cylinder bores to provide cooling therebetween;
a first plurality of projections extending outwardly from the outer surface, the first plurality of projections formed integrally with the additive manufactured liner wall during the additive manufacturing process, wherein the first plurality of projections is configured to facilitate mechanically locking the cylinder bore liner insert during the casting of the cylinder bore liner insert within the engine block;
a second plurality of projections extending inwardly from the inner surface into the cylinder bore, the second plurality of projections formed integrally with the additive manufactured liner wall during the additive manufacturing process; and
a spray bore liner sprayed onto the inner surface and mechanically locked with the second plurality of projections.
